(19) United States
(12) Patent Application Publication
(10) Pub. No.: US 2005/0138574 A1
(43) Pub. Date: Jun. 23, 2005

(54) Interactive icon

(76) Inventor: Jyh-Han Lin, Coral Springs, FL (US)

Correspondence Address: Larry G. Brown;Motorola, Inc., Law Department, 8000 West Sunrise Boulevard, Fort Lauderdale, FL, 33322, US

(21) Appl. No.: 10/738,016

(22) Filed: Dec. 17, 2003

(51) Int. Cl. G06F 3/00

(52) U.S. Cl. 715/811; 715/821; 715/828; 715/835; 715/836; 715/837; 715/838; 715/839; 715/840; 715/846; 715/849; 715/851; 715/852

(57) ABSTRACT

Networked icon (108) interacts with the electronic device user and uses user input (102), context information (104) and network information (106) to automatically update the icon's representation to the user. Icon (108) is also associated with user profile interaction history information (112), navigation logic (114), multimedia presentations (116), network interfaces (118), etc. in order to provide the user with enhanced interaction with the electronic device the icon (108) is associated with.

### TECHNICAL FIELD

This invention relates in general to the field of electronic device user interfaces and more particularly to an interactive icon for use in an electronic device.

### BACKGROUND

Electronic devices such as radio communication devices (e.g. cellular telephones) are becoming multimedia rich when it comes to Graphical User Interfaces (GUIs). With the acceleration of new features, new GUIs are including sounds and animations to provide the electronic device users a better interactive experience while operating his/her radio communication device. Although current GUI's include icons that are displayed on the radio communication device display, they simply serve as static graphical pointers which help a user navigate the radio communication device's menu. A need exists in the art for an icon that can provide an improvement over static icons presently in use.

### BRIEF DESCRIPTION OF THE DRAWINGS

The features of the present invention, which are believed to be novel, are set forth with particularity in the appended claims. The invention may best be understood by reference to the following description, taken in conjunction with the accompanying drawings, in the several figures of which like reference numerals identify like elements, and in which:

FIG. 1 shows a diagram of an icon with on-line multimedia capability in accordance with an embodiment of the invention.

FIG. 2 shows a diagram of an icon with user interaction profile in accordance with an embodiment of the invention.

FIG. 3 shows a diagram of an icon with network interface in accordance with an embodiment of the invention.

FIG. 4 shows a block diagram of a radio communication device in accordance with an embodiment of the invention.

FIG. 5 shows a diagram of a radio communication device in accordance with an embodiment of the invention.

FIG. 6 shows how an icon may change over time in accordance with an embodiment if the invention.

FIG. 7 shows how an icon may change from text to voice in accordance with an embodiment of the invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures.

Java enabled mobile handsets can contain many types of Java applications, including networked applications. The present invention provides for a user-selectable icon that can be implemented as networked Java applications with on-line multimedia capability. This new framework turns a passive data-only icon into an active program that can interact with a user and self-update based on context and/or time information. Although the invention is described using the Java language, other programming languages can also support the interactive icons described.

The icon is represented as a program based on Java (or other programming languages) which include one or more of the following elements:
Navigation logic to launch the associated application. The icon interacts with the user to collect additional inputs to launch the application;
One or more multimedia representations that are rendered when selected.

The representation to be graphically rendered can be context aware (e.g., location, time, etc.);
One or more associated URL's that provide update information to the user, for example, new video clips or visual icon;
Meta data about the application, including licensing, digital rights, update site, etc;
A log on the usages and updates of the application. This log is used to build a usage profile(s) that contain such things as most recently or most used user inputs, etc; and/or
Language dependent resources.

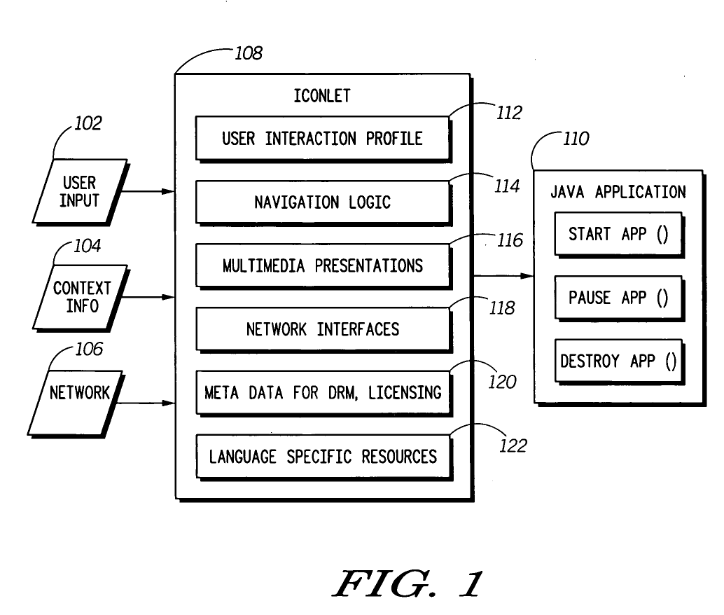

Referring now to FIG. 1, there is shown a block diagram of an icon 108 with on-line multimedia capability in accordance with an embodiment of the invention. The multimedia networked icon will be referred to as an iconLet. The iconLet 108 interacts with user input(s) 102, such as the user activating a key on the radio telephone, context information 104 such as information presently being accessed by the user, time, date, etc., and network information 106 such as information sent to the radio communication device by the communication network the radio is operating in. The iconLet 108 is associated to one or more Java (or other programming language) applications 110.

The iconLet 108 includes a user interaction profile section 112 and navigation logic 114 that interacts with the user with stored profile information to minimize the key presses in collecting user input. It then uses the information to launch the Java application 110. The navigation logic 114 can also provide the ability to launch the Java application 110 automatically given some local or network triggers (e.g., user selecting a specific menu item on the radio telephone GUI, user enters a specific network coverage area, etc.).

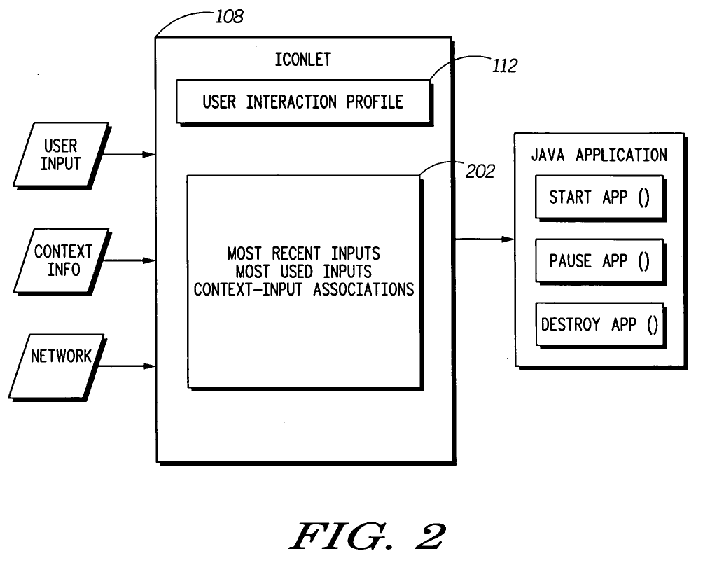

Shown in FIG. 2 is a further breakdown of the user interaction profile which includes items such as the most recent user inputs, most used inputs by the user and context-input associations (e.g., user always inputs certain information after 9:00 P.M.). The user interaction profile 112 can comprise one or more software routines associated with the IconLet 108 and can also include stored user input history information.

Referring back to FIG. 1, the iconLet 108 also includes one or more multimedia presentations 116 that are stored and rendered when selected. What representation is to be rendered can be context aware (e.g., radio telephone location, time, etc.). As an illustrative example, when the flip housing of a “flip-phone” is closed, the rendering can be sound only. The multimedia presentations 116 are again software routines that are linked to the iconLet 108 and activated by user input 102, context information 104 or network interaction 106, or a combination of these items.

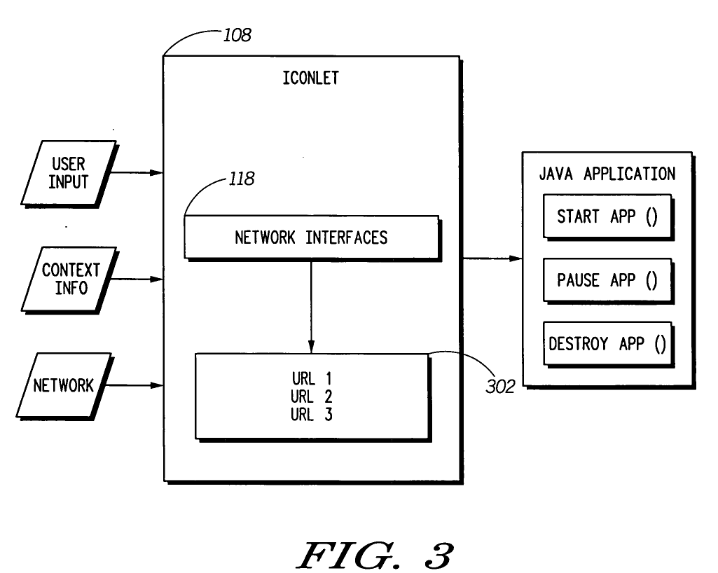

The iconLet 108 as shown in FIG. 1 also includes network interfaces 118 that can gather information such as information from linked URL addresses 302 as further detailed in FIG. 3. Referring back to FIG. 1, the iconLet 108 can also be linked to meta data 120 about the application, including licensing, digital rights information, licensing update sites, etc.

Also shown as part of iconLet 108 are language specific resources 122. Language specific resources 122 can for example comprise voice icons in different languages that get activated when the radio communication device is physically located in different locations (e.g., different countries).

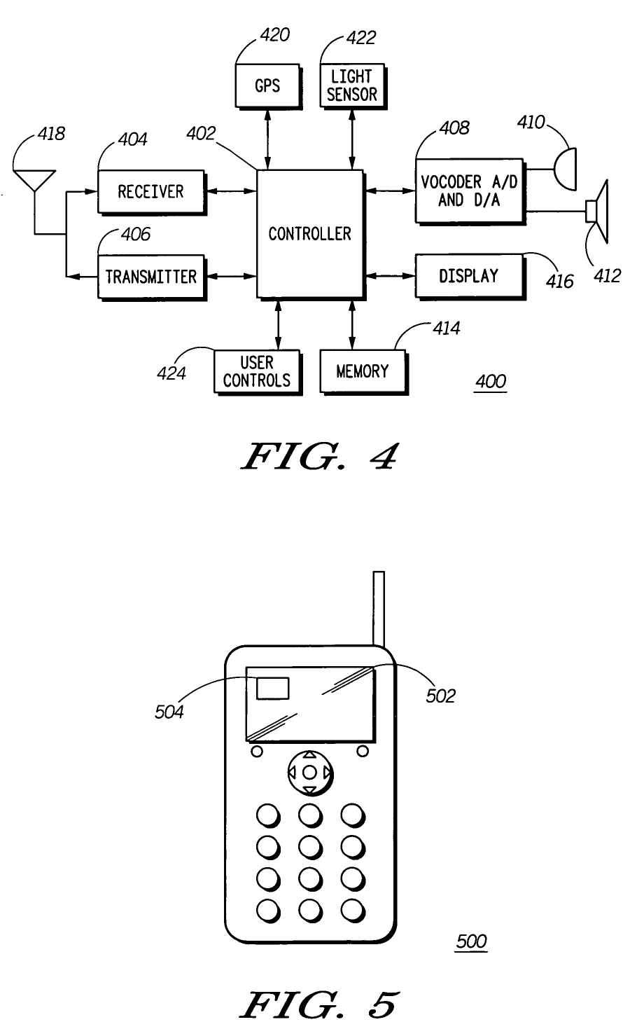

Referring to FIG. 4, there is shown a block diagram of an electronic device such as a radio communication device 400 that can take advantage of the interactive icon 108 of the present invention. Cellular telephone 400 includes an antenna 418 which is selectively coupled to conventional receiver 404 and transmitter 406 sections. A controller 402, such as a microprocessor and/or Digital Signal Processor (DSP), provides the overall control for telephone 400. Controller 402 also executes programs required by the icon 108 and acts as the icon generator by taking inputs from the user input 102, context information 104 and network information 106 and using the inputted information along with the user interaction profile 112, navigation logic 114, etc. to generate the iconLet 108. Memory 414 coupled to the controller 402 such as Random Access Memory (RAM), Read-Only Memory (ROM), FLASH, etc. stores all of the algorithms and variables needed by cellular telephone 400. Memory 414 also stores the user interaction profile 112 information as well as any other information related to the generation of iconLet 108.

A display 416 provides visual information to the cellular telephone user. Display 416 is used to graphically display the iconLet 108. An audio processing block 408 which can include a vocoder and Analog-to-Digital (A/D) and Digital-to-Analog (D/A) block provides all the necessary audio processing for both incoming and outgoing voice traffic. Coupled to the audio processing block 408 is a speaker 412 and microphone 410.

One or more context capturing devices such as Global Positioning System (GPS) receiver section 420 and light sensor 422 are coupled to controller 402 and provide some of the necessary context information 104 used by the iconLet 108. Other context information such as time can be provided by the communication system to the radio 400 or the radio can further include a clock provided by either hardware and/or software controlled by controller 402. Controller 402 executes all of the necessary routines necessary to perform the iconLet functions, while memory 414 stores all of the software routines needed by the iconLet 108. User controls 424 such as a keypad and other switches located on the radio communication provide the user input 102 used by the iconLet 108. Other user inputs 102 can be received by the microphone 410 in the form of audio or voice signals from the user or the radio's environment (e.g., radio user providing voice commands, or the radio measuring the ambient noise).

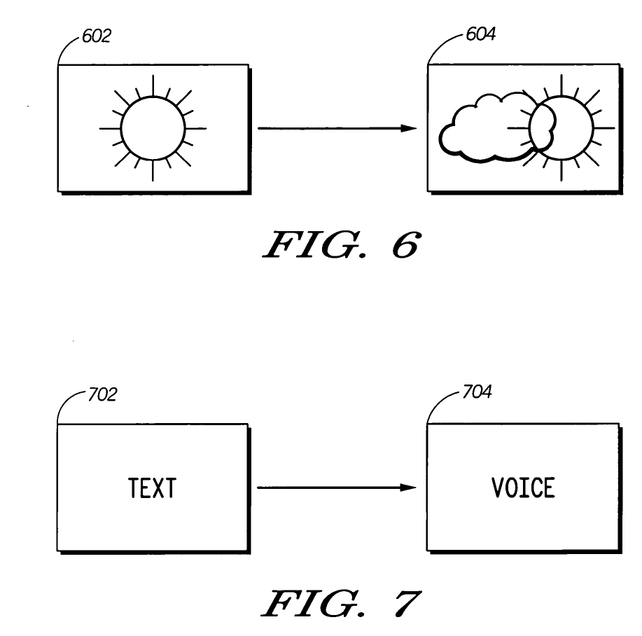

Referring to FIG. 5, there is shown a radio communication device such as a cellular telephone 500 having a display for displaying an iconLet 504. In FIG. 6, there is shown a graphical iconLet 602 depicting a sun which informs the user that the weather for the day is sunny. The iconLet 602 may have been generated after the iconLet 108 had used its network interfaces 118 to gather information from a weather URL that the radio communication device 500 communicated with wirelessly (e.g., requested information from the URL address from the communication system). After gathering the weather information the iconLet 108 presented the information in a visual form. The iconLet 602 based on changes in context such as a change in time or location of the cellular telephone 500 provides an updated graphical view of the weather in updated iconLet 604. This change in graphical information could have been prompted by the cellular telephone 500 traveling to a new location as determined by GPS 420 and the GPS 420 interacting with the network interface 118 to find out the weather conditions in the new location.

In FIG. 7, there is shown a text based iconLet 702. Using the context information 104 gathered by the microphone 402 the iconLet 108 automatically switches to a voice or audio iconLet 704 under low light conditions as determined by the context information 104 provided by light sensor 422 (e.g., cellular telephone user entered a dark room).

Although a few situations have been described above, the iconLet of the present invention can perform many different functions. For example, an iconLet that changes over time could be an iconLet that changes according to the latest market index information gathered by the network interface 118 interacting with a financial website to gather stock prices information and display it as part of the icon. The information can change automatically as the day goes on at predetermined periods of time (e.g., every hour, etc.). The iconLet 108 replaces conventional passive icons with active (Java or other programming language) programs that are multimedia rich and can interact with the user intelligently. The IconLet 108 also “learns” to improve future interaction with the user by profiling pass usages and minimizing the key presses required to complete often repeated tasks.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. An electronic device, comprising:
a display;
an input for receiving user input information;
an input for receiving context information; and
an icon generator coupled to the display for displaying an icon on the display that changes based on the input information and context information that is received.

2. An electronic device as defined in claim 1, further comprising:
an input for receiving information from a network the electronic device is operating in, and the icon generator changes the icon based on the network information that is received.

3. An electronic device as defined in claim 1, wherein the icon generator is coupled to a user interaction profile storage area which stores user interaction history that is used by the icon generator for changing the icon.

4. An electronic device as defined in claim 1, wherein the icon generator is coupled to one or more multimedia presentations that are selected by the icon generator for presentation as part of the icon.

5. An electronic device as defined in claim 1, wherein the icon generator is coupled to a network interface for receiving information from a network that is used to change information presented via the icon.

6. An electronic device as defined in claim 5, wherein the network interface is coupled to the internet and can receive information from internet web sites that is used to update information presented by the icon.

7. An electronic device as defined in claim 1, wherein the electronic device comprises a radio communication device.

8. An electronic device as defined in claim 2, further comprising language specific resources coupled to the icon generator, and the language specific resources cause a change in the language that is used in the form of text or audio as part of the icon.

9. An electronic device as defined in claim 1, wherein the icon comprises an application written in a networked programming language.

10. An electronic device as defined in claim 9, wherein the programming language comprises Java programming language.

11. A method for generating an icon used in an electronic device, comprising the steps of:
profiling past usage of the electronic device; and
presenting the icon based on the past usage profile.

12. A method as defined in claim 11, further comprising the step of:
determining the current context of the electronic device, and using the context information that is determined to update how the icon is presented.

13. A method as defined in claim 12, further comprising the step of:
collecting usage profile information that is used to update how the icon is presented.

14. A method as defined in claim 12, further comprising the step of:
receiving information from a network the electronic device is operating in and using the network information to update how the icon is presented.

15. A method as defined in claim 12, further comprising the step of: selecting from among a plurality of multimedia presentations associated with the icon based on the context information.

16. A method as defined in claim 12, further comprising the step of:
selecting from among language specific resources that are to be used with the presentation of the icon based on the context information.

17. A method as defined in claim 12, further comprising the step of:
providing meta data about the application used to generate the icon.

18. A method as defined in claim 12, wherein the icon may change from a text based icon to an audio icon based on the context information.

19. An electronic device comprising:
a controller; and
an icon implemented in a networked programming language executed by the controller.

20. An electronic device as defined in claim 19, wherein the networked programming language comprises Java.

21. An electronic device as defined in claim 19, wherein the electronic device comprises a radio communication device.

22. An electronic device as defined in claim 19, wherein the icon learns to interaction with the user of the electronic device by profiling past usage of the electronic device by the user.
